(19) United States
(12) Patent Application Publication
(10) Pub. No.: US 2020/0349687 A1
(43) Pub. Date: Nov. 5, 2020

(54) IMAGE PROCESSING METHOD, DEVICE, UNMANNED AERIAL VEHICLE, SYSTEM, AND STORAGE MEDIUM

(71) Applicant: SZ DJI TECHNOLOGY CO., LTD., Shenzhen (CN)

(72) Inventors: Chao WENG, Shenzhen (CN); Lei YAN, Shenzhen (CN)

(21) Appl. No.: 16/930,074

(22) Filed: Jul. 15, 2020

Related U.S. Application Data
(63) Continuation of application No. PCT/CN2018/119118, filed on Dec. 4, 2018.

(51) Int. Cl. G06T 5/50; G06T 5/00; G06T 7/13; B64C 39/02

(52) U.S. Cl. CPC G06T 5/50; G06T 5/002; G06T 7/13; B64C 2201/127; G06T 2207/20221; G06T 2207/10048; G06T 2207/10024; B64C 39/024

(57) ABSTRACT

An image processing method includes: obtaining a first band image and a second band image; registering the first band image and the second band image; performing an edge detection on the registered second band image to obtain an edge image; and performing a fusion processing on the registered first band image and the edge image to obtain a target image. The present disclosure also provides an image processing device and a UAV using the above method.

### CROSS-REFERENCE TO RELATED APPLICATION

This application is a continuation of International Application No. PCT/CN2018/119118, filed on Dec. 4, 2018, the entire content of which is incorporated herein by reference.

### TECHNICAL FIELD

The present disclosure relates to the field of image processing technology and, more particularly, to an image processing method, a device, an unmanned aerial vehicle (UAV), a system, and a storage medium.

### BACKGROUND

With development of flight technology, unmanned aerial vehicles (UAVs) have become a popular research topic, and are widely used in plant protection, aerial photography, forest fire monitoring, and other fields, bringing many conveniences to people's life and work.

In aerial photography applications, a camera is usually used to photograph a subject. In practice, it is found that an image obtained in this way includes single information. For example, when an infrared photographing lens is used to photograph a subject, the infrared photographing lens can obtain infrared radiation information of the subject by infrared detection. The infrared radiation information can better reflect temperature information of the subject, but the infrared photographing lens is not sensitive to brightness change of a photographing scene, image resolution is low, and a captured image cannot reflect detailed feature information of the subject. As another example, when a visible light photographing lens is used to photograph a subject, the visible light photographing lens can obtain a higher resolution image, which can reflect detailed feature information of the subject. But the visible light photographing lens cannot obtain infrared radiation information of the subject, and a captured image cannot reflect temperature information of the subject. Therefore, how to obtain images with higher quality and richer information has become a research hotspot.

### SUMMARY

In accordance with the disclosure, there is provided an image processing method including: obtaining a first band image and a second band image; registering the first band image and the second band image; performing an edge detection on the registered second band image to obtain an edge image; and performing a fusion processing on the registered first band image and the edge image to obtain a target image.

Also in accordance with the disclosure, there is provided an image processing device, including: a memory, containing a computer program, the computer program including program instructions; and a processor, coupled with the memory and, when the program instructions being executed, configured to perform: obtaining a first band image and a second band image; registering the first band image and the second band image; performing an edge detection on the registered second band image to obtain an edge image; and performing a fusion processing on the registered first band image and the edge image to obtain a target image.

Also in accordance with the disclosure, there is provided an unmanned aerial vehicle (UAV), including: a fuselage; a power system, provided on the fuselage for providing flying power; an image photographing device, mounted on the fuselage; and a processor, configured to perform: obtaining a first band image and a second band image; registering the first band image and the second band image; performing an edge detection on the registered second band image to obtain an edge image; and performing a fusion processing on the registered first band image and the edge image to obtain a target image.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an unmanned aerial vehicle (UAV) system according to various exemplary embodiments of the present disclosure.

FIG. 2 is a schematic flowchart of an image processing method according to various exemplary embodiments of the present disclosure.

FIG. 3 is a schematic flowchart of another image processing method according to various exemplary embodiments of the present disclosure.

FIG. 4 is a schematic flowchart of obtaining a gradient field of an image to be fused according to various exemplary embodiments of the present disclosure.

FIG. 5 is a schematic diagram of obtaining a gradient field of an image to be fused according to various exemplary embodiments of the present disclosure.

FIG. 6 is a schematic flowchart of a method for calculating color values of pixels in an image to be fused according to various exemplary embodiments of the present disclosure.

FIG. 7 is a schematic structural diagram of an image processing device according to various exemplary embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

The present disclosure has provided an image processing method. The image processing method can be applied to an unmanned aerial vehicle (UAV) system. An image photographing device is mounted on a UAV in the UAV system. After the image processing method registers a first band image and a second band image captured by using the image photographing device, an edge image of the registered second band image is extracted, and a target image is obtained by fusing the edge image and the registered first band image. The target image includes both information of the first band image and edge information of the second band image. More information can be obtained from the target image, which improves quality of captured images.

Embodiments of the present disclosure can be applied to fields of military defense, remote sensing detection, environmental protection, traffic detection, or disaster detection. Applications in these fields are mainly based on aerial photography of UAVs to obtain environmental images, which are analyzed and processed to obtain corresponding data. For example, in a field of environmental protection, environment images of a certain area are obtained by using aerial photography of UAVs for the area. If the area is an area where a river is located, environmental images of the area are analyzed to obtain data about water quality of the river. According to the data about the water quality of the river, it can be judged whether the river is polluted.

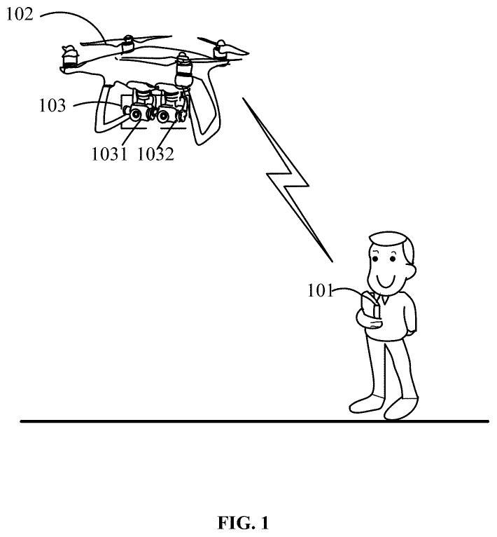

To facilitate understanding of the image processing method provided in the embodiments of the present disclosure, a UAV system according to the embodiments of the present disclosure is introduced. Referring to FIG. 1, which is a schematic structural diagram of a UAV system according various exemplary embodiments of the present disclosure, the UAV system includes: a smart terminal 101, a UAV 102, and an image photographing device 103.

The smart terminal 101 may be a control terminal of a UAV, and may alternatively be one or more of a remote controller, a smart phone, a tablet computer, a laptop computer, a ground station, and a wearable device (watch, bracelet). The UAV 102 may be a rotary-wing UAV, such as a four-rotor UAV, a six-rotor UAV, an eight-rotor UAV, or a fixed-wing UAV. The UAV 102 includes a power system, which is used to provide flying power for the UAV. The power system may include one or more of a propeller, a motor, and an Electronic Speed Controller (ESC).

The image photographing device 103 is used to capture images when a photographing instruction is received. The image photographing device is mounted on the UAV 102. In one embodiment, the UAV 102 may further include a gimbal, and the image photographing device 103 is mounted on the UAV 102 via the gimbal. The gimbal is a multi-axis transmission and stabilization system. A gimbal motor is used to compensate a photographing angle of the image photographing device by adjusting a rotation angle of a rotating shaft, and to prevent or reduce image photographing device shake by setting an appropriate buffer mechanism.

In one embodiment, the image photographing device 103 includes at least an infrared photographing module 1031 and a visible light photographing module 1032. The infrared photographing module 1031 and the visible light photographing module 1032 have different photographing advantages. For example, the infrared photographing module 1031 can detect infrared radiation information of a subject, and a captured image can better reflect temperature information of the subject. The visible light photographing module 1032 can capture a higher resolution image, which can reflect detailed feature information of a subject.

In one embodiment, the smart terminal 101 may also be configured with an interactive device for realizing human-computer interactions. The interactive device may be one or more of a touch screen, a keyboard, keys, a joystick, and a dial wheel. A user interface can be provided on the interactive device. During a flight of a UAV, a user can set a photographing position through the user interface. For example, a user can enter photographing position information on the user interface, or the user can perform photographing position setting touch operations (such as a click operation or a sliding operation) on a flight trajectory of the UAV to set a photographing position. Alternatively, the smart terminal 101 is used to set a photographing position according to one touch operation. In one embodiment, after detecting photographing position information input by a user, the smart terminal 101 sends the photographing position information to the image photographing device 103. When the UAV 102 flies to the photographing position, the image photographing device 103 is used to photograph a subject in the photographing position.

In one embodiment, when the UAV 102 flies to the photographing position and before a subject in the photographing position is photographed, the infrared photographing module 1031 and the visible light photographing module 1032 included in the image photographing device 103 may also be detected whether they are in a registered state at the photographing position: if they are in the registered state, the infrared photographing module 1031 and the visible light photographing module 1032 are used to photograph the subject in the photographing position; and if they are not in the registered state, photographing operations may not be executed, and at a same time, prompt information can be output for prompting to register the infrared photographing module 1031 and the visible light photographing module 1032.

In one embodiment, the infrared photographing module 1031 is used to photograph a subject in the photographing position to obtain a first band image, and the visible light photographing module 1032 is used to photograph the subject at the photographing position to obtain a second band image. The image photographing device 103 may perform a registering processing on the first band image and the second band image, extract an edge image of the registered second band image, and fuse the edge image with the registered first band image to obtain a target image. The registering processing mentioned here refers to processing of the first band image and the second band image, such as rotation, cropping, etc. The above registering processing at the photographing position refers to adjustment of physical structures of the infrared photographing module 1031 and the visible light photographing module 1032 before photographing.

In another embodiment, the image photographing device 103 may also send the first band image and the second band image to the smart terminal 101 or the UAV 102, and the smart terminal 101 or the UAV perform the above fusion operation to obtain a target image. The target image includes both information of the first band image and edge information of the second band image, more information can be obtained from the target image, and information diversity of captured images is improved, thereby improving photographing quality.

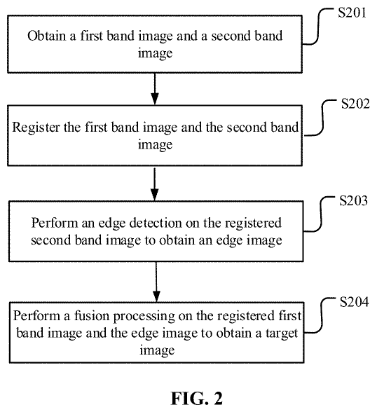

Referring to FIG. 2, which is a schematic flowchart of an image processing method according to various exemplary embodiments of the present disclosure, the image processing method may be applied to the above-mentioned UAV system, and more particularly applied to an image photographing device. The image processing method may be executed by the image photographing device. The image processing method shown in FIG. 2 may include S201, S202, S203, and S204.

In S201, a first band image and a second band image are obtained.

In one embodiment, the first band image and the second band image are obtained by using two different photographing modules to photograph a subject containing a same object, that is, the first band image and the second band image contain a same image element, but information of the same image element that can be reflected by the first band image and the second band image is different. For example, the first band image focuses on reflecting temperature information of the subject, and the second band image focuses on reflecting detailed feature information of the subject.

In one embodiment, a method to obtain a first band image and a second band image may be that a subject is photographed by using the image photographing device, or images sent by another device are received by using the image photographing device. The first band image and the second band image may be captured by using a photographing device capable of capturing multiple band signals. In one embodiment, the image photographing device includes an infrared photographing module and a visible light photographing module, the first band image may be an infrared image captured by using the infrared photographing module, and the second band image may be a visible light image captured by using the visible light photographing module.

In one embodiment, the infrared photographing module can capture infrared signals with a wavelength of about 10⁻³˜7.8×10⁻⁷ m, and the infrared photographing module can detect infrared radiation information of a subject, so the first band image can better reflect temperature information of the subject. The visible light photographing module can capture visible light signals with a wavelength of about (78˜3.8)×10⁻⁶ cm, and the visible light photographing module can take a higher resolution image, so the second band image can reflect detailed feature information of a subject.

In S202, the first band image and the second band image are registered.

In one embodiment, the first band image and the second band image are respectively captured by using an infrared photographing module and a visible light photographing module. The infrared photographing module and the visible light photographing module are different in position, and/or in photographing parameters, which results in difference between the first band image and the second band image, such as different sizes of the two images and different resolutions of the two images. Therefore, to ensure accuracy of image fusion, before performing other processing on the first band image and the second band image, it is necessary to register the first band image and the second band image.

In one embodiment, registering the first band image and the second band image includes: based on calibration parameters of the infrared photographing module and calibration parameters of the visible light photographing module, the first band image and the second band image are registered. The calibration parameters include internal parameters, external parameters, and distortion parameters of a photographing module. The internal parameters refer to parameters related to characteristics of the photographing module, including a focal length and a pixel size of the photographing module. The external parameters refer to parameters of the photographing module in a global coordinate system including a position and a rotation direction of the photographing module.

The calibration parameters are calibrated for the infrared photographing module and the visible light photographing module before the infrared photographing module and the visible light photographing module are used for photographing. In the embodiments of the present disclosure, a method of performing parameter calibration on the infrared photographing module and the visible light photographing module separately may include: obtaining a sample image for parameter calibration; photographing the sample image by using the infrared photographing module and the visible light photographing module to obtain an infrared image and a visible light image; and analyzing and processing the infrared image and the visible light image separately, such that when a registering rule is satisfied between the infrared image and the visible light image, parameters of the infrared photographing module and the visible light photographing module are calculated based on the infrared image and the visible light image, and are taken as respective calibration parameters of the infrared photographing module and the visible light photographing module.

When the registering rule is unsatisfied between the infrared image and the visible light image, photographing parameters of the infrared photographing module and the visible light photographing module can be adjusted, and the sample image is photographed again until the registering rule is satisfied between the infrared image and the visible light image. The registering rule may refer to that the infrared image and the visible light image have a same resolution, and a same subject has a same position in the infrared image and the visible light image.

It can be understood that the above is one feasible method to set calibration parameters of an infrared photographing module and a visible light photographing module provided by the embodiments of the present disclosure. In other embodiments, the image photographing device may also use other methods to set calibration parameters of an infrared photographing module and a visible light photographing module.

In one embodiment, after setting the calibration parameters for the infrared photographing module and the visible light photographing module, the image photographing device may store the calibration parameters of the infrared photographing module and the calibration parameters of the visible light photographing module for subsequent use of the calibration parameters of the infrared photographing module and the visible light photographing module to register the first band image and the second band image.

In one embodiment, implementation of S202 may include: obtaining the calibration parameters of the infrared photographing module and calibration parameters of the visible light photographing module; and performing adjustment operations on the first band image according to the calibration parameters of the infrared photographing module, and/or performing adjustment operations on the second band image according to the calibration parameters of the visible light photographing module. The adjustment operations include one or more of rotation, zoom, translation, and cropping.

Performing the adjusting operations on the first band image according to the calibration parameters of the infrared photographing module may include: obtaining an internal parameter matrix and distortion coefficients included in the calibration parameters of the infrared photographing module; calculating to obtain a rotation vector and a translation vector of the first band image according to the internal parameter matrix and the distortion coefficients; and rotating or translating the first band image by using the rotation vector and the translation vector of the first band image. Similarly, performing the adjustment operations on the second band image according to the calibration parameters of the visible light photographing module can also use a same method as described above to perform the adjustment operations on the second band image.

Optionally, based on the calibration parameters of the infrared photographing module and the calibration parameters of the visible light photographing module, the first band image and the second band image are registered respectively, so that resolutions of the registered first band image and the registered second band image are the same, and positions of a same subject in the registered first band image and the registered second band image are the same, to ensure that quality of a fused image obtained subsequently based on the registered first band image and the registered second band image is high.

In other embodiments, to ensure accuracy of a target image obtained by fusing a first band image and a second band image and convenience of a fusion process, in addition to registering the first band image and the second band image, the infrared photographing module and the visible light photographing module can be registered in physical structures before the infrared photographing module and the visible light photographing module are used for photographing.

In S203, an edge detection on the registered second band image is performed to obtain an edge image.

In one embodiment, an edge image refers to an image obtained by extracting edge feature of the registered second band image. An edge of an image is one of basic features of the image, which carries most information of the image. The edge of the image exists in an irregular structure and unstable phenomenon of the image, that is, exists at abrupt points of signals in the image, such as abrupt points of a gray level, abrupt points of a texture structure, and abrupt points of color, etc.

Normally, an image processing such as an edge detection and an image enhancement is performed based on an image gradient field. In one embodiment, since the registered second band image is a color image, which is a 3-channel image, corresponding to gradient fields of 3 channels or 3 primary colors. If an edge detection is performed based on the registered second band image, each color needs to be detected separately, that is, the gradient fields of the three primary colors must be analyzed separately. Since gradient directions of the primary colors at a same point may be different, obtained edges may also be different, resulting in errors occurred on detected edges.

In summary, before performing the edge detection on the registered second band image, the 3-channel color image needs to be converted into a 1-channel grayscale image, and the grayscale image corresponds to one gradient field, which ensures accuracy of edge detection results.

Alternatively, a method of performing the edge detection on the registered second band image to obtain the edge image may include: converting the registered second band image into a grayscale image; and perform the edge detection on the grayscale image to obtain the edge image. Alternatively, an edge detection algorithm may be used to perform the edge detection on the grayscale image to obtain the edge image. Edge detection algorithms can include first-order detection algorithms and second-order detection algorithms, of which commonly used algorithms in first-order detection algorithms include Canny operator, Robert (cross-difference) operator, compass operator, etc., and commonly used in second-order detection algorithms include Marr-Hildreth.

In one embodiment, to improve quality of a target image, after an image photographing device performs an edge processing on a second band image to obtain an edge image, and before a registered first band image and the edge image are fused, the image photographing device performs an alignment processing on the registered first band image and the edge image based on feature information of the registered first band image and feature information of the edge image.

In one embodiment, a method of performing the alignment processing on the registered first band image and the edge image based on the feature information of the registered first band image and the feature information of the edge image may include: obtaining the feature information of the registered first band image and the feature information of the edge image; determining a first offset of the feature information of the registered first band image relative to the feature information of the edge image; and adjusting the registered first band image according to the first offset.

The image photographing device can obtain the feature information of the registered first band image and the feature information of the edge image, compare the feature information of the registered first band image with the feature information of the edge image, and determine the first offset of the feature information of the registered first band image relative to the feature of the edge image. The first offset mainly refers to a position offset of feature points, and the registered first band image is adjusted according to the first offset to obtain an adjusted registered first band image. For example, the registered first band image is stretched horizontally or vertically, or indented horizontally or vertically, according to the first offset, to align the adjusted registered first band image with the edge image. Further, the adjusted registered first band image and the edge image are fused to obtain a target image.

In another embodiment, a method of performing the alignment processing on the registered first band image and the edge image based on the feature information of the registered first band image and the feature information of the edge image may further include: obtaining the feature information of the registered first band image and the feature information of the edge image; determining a second offset of the feature information of the edge image relative to the feature information of the registered first band image; and adjusting the edge image according to the second offset.

The image photographing device can obtain the feature information of the registered first band image and the feature information of the edge image, compare the feature information of the registered first band image with the feature information of the edge image, and determine the second offset of the feature information of the edge image relative to the feature of the registered first band image. The second offset mainly refers to a position offset of feature points, and the edge image is adjusted according to the second offset to obtain an adjusted edge image. For example, according to the second offset, the edge image is stretched horizontally or vertically, or indented horizontally or vertically, to align the adjusted edge image with the registered first band image. Further, the adjusted edge image and the registered first band image is fused to obtain a target image.

In S204, a fusion processing is performed on the registered first band image and the edge image to obtain a target image.

In one embodiment of the present disclosure, the registered first band image and the edge image are fused to obtain the target image. The target image includes both information of the first band image and edge information of the second band image.

In one embodiment, a Poisson fusion algorithm may be used to fuse the registered first band image and the edge image to obtain the target image. In other embodiments, the registered first band image and the edge image may also be fused through a fusion method based on weighted average, a fusion algorithm based on an absolute value being large, and the like.

In one embodiment, performing the fusion processing on the registered first band image and the edge image to obtain the target image includes: superimposing the registered first band image and the edge image to obtain an image to be fused; obtaining a color value of each pixel in the image to be fused; and rendering the image to be fused based on the color value of each pixel in the image to be fused, and determining the image to be fused after rendering as the target image.

In one embodiment, if a Poisson fusion algorithm is used to fuse the registered first band image and the edge image, general steps of obtaining the color value of each pixel in the image to be fused are: calculating a divergence value of each pixel of the image to be fused; and calculating the color value of each pixel in the image to be fused according to the divergence value of each pixel and a coefficient matrix of the image to be fused. Because the color value of each pixel is obtained based on some feature information of the image to be fused, and feature information of the first band image and feature information of the edge image of the second band image are integrated into the image to be fused, so that the color value of each pixel can be used to render the image to be fused to obtain a fused image that includes both the feature information of the first band image and edge feature of the second band image.

In the embodiments of the present disclosure, an obtained first band image and an obtained second band image are registered, an edge detection is performed on the registered second band image to obtain an edge image, and a fusion processing is performed on the registered first band image and the edge image to obtain a target image. The target image is obtained by fusing the registered first band image and the edge image of the registered second band image. Therefore, the target image includes information of the first band image and edge information of the second band image, and more information can be obtained from the target image, which improves quality of captured images.

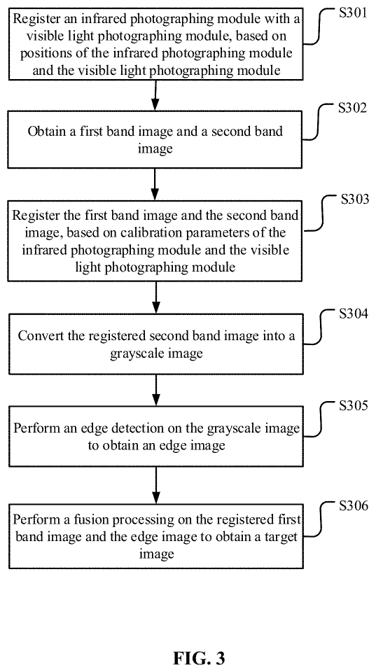

Referring to FIG. 3, which is a schematic flowchart of another image processing method according to various exemplary embodiments of the present disclosure, the image processing method may be applied to the UAV system shown in FIG. 1. In one embodiment, the UAV system includes an image photographing device, which includes an infrared photographing module and a visible light photographing module. An image captured by using the infrared photographing module is a first band image, and an image captured by using the visible light photographing module is a visible light image. In the image processing method shown in FIG. 3, the first band image is an infrared image. The image processing method shown in FIG. 3 may include S301, S302, S303, S304, S305, and S306.

In S301, the infrared photographing module and the visible light photographing module are registered based on a position of the infrared photographing module and a position of the visible light photographing module.

In the embodiments of the present disclosure, to ensure accuracy of a target image obtained by fusing a first band image and an edge image and convenience of a fusion process, the infrared photographing module and the visible light photographing module can be registered on physical structures, before the infrared photographing module and the visible light photographing module are used for photographing. Registering the infrared photographing module and the visible light photographing module on physical structures includes: registering the infrared photographing module and the visible light photographing module based on a position of the infrared photographing module and a position of the visible light photographing module.

In one embodiment, a criterion to determine that the infrared photographing module and the visible light photographing module have been registered on physical structures is that the infrared photographing module and the visible light photographing module satisfy a central horizontal distribution, and a position difference value between the infrared photographing module and the visible light photographing module is less than a preset position difference value. The position difference value between the infrared photographing module and the visible light photographing module is smaller than the preset position difference value to ensure that a field of view (FOV) of the infrared photographing module can cover an FOV of the visible light photographing module, and there is no interference between the FOV of the infrared photographing module and the FOV of the visible light photographing module.

In one embodiment, registering the infrared photographing module and the visible light photographing module based on the position of the infrared photographing module and the position of the visible light photographing module includes: calculating a position difference value between the infrared photographing module and the visible light photographing module, based on a position of the infrared photographing module relative to the image photographing device and a position of the visible light photographing module relative to the image photographing device; and if the position difference value is greater than or equal to a preset position difference value, triggering adjustment of the position of the infrared photographing module or the position of the visible light photographing module, so that the position difference value is less than the preset position difference value.

In another embodiment, registering the infrared photographing module and the visible light photographing module based on the position of the infrared photographing module and the position of the visible light photographing module further includes: determine whether a horizontal distribution condition is satisfied between a position of the infrared photographing module and a position of the visible light photographing module; and if the horizontal distribution condition is unsatisfied between the position of the infrared photographing module and the position of the visible light photographing module, triggering the adjustment of the position of the infrared photographing module or the position of the visible light photographing module, so that the central horizontal distribution condition is satisfied between the infrared photographing module and the visible light photographing module.

In summary, based on the position of the infrared photographing module and the position of the visible light photographing module, the infrared photographing module and the visible light photographing module are registered, that is, the infrared photographing module and the infrared photographing module on the image photographing device are detected to determine whether the central horizontal distribution condition is met, and/or whether the relative position of the infrared photographing module and the visible light photographing module on the image photographing device is less than or equal to the preset position difference value. When it is detected that the central horizontal distribution condition is unsatisfied between the infrared photographing module and the visible light photographing module on the image photographing device, and/or the relative position of the infrared photographing module and the visible light photographing module on the image photographing device is greater than the preset position difference value, it indicates that the infrared photographing module and the visible light photographing module are not registered in structures, and the infrared photographing module and/or the visible light photographing module need to be adjusted.

In one embodiment, when it is detected that the infrared photographing module and the visible light photographing module are not registered in structures, a prompt message may be output, and the prompt message may include an adjustment method for the infrared photographing module and/or the visible light photographing module. For example, a prompt message includes adjusting the infrared photographing module to the left by 5 mm. The prompt message is used to prompt a user to adjust the infrared photographing module and/or the visible light photographing module, so that the infrared photographing module and the visible light photographing module can be registered. Or, when it is detected that the infrared photographing module and the visible light photographing module are not registered in structures, the image photographing device may adjust positions of the infrared photographing module and/or the visible light photographing module to enable the infrared photographing module and the visible light photographing module to be registered.

When it is detected that the central horizontal distribution condition is satisfied between the infrared photographing module and the visible light photographing module on the image photographing device, and/or the relative position of the infrared photographing module and the visible light photographing module on the image photographing device is less than or equal to the preset position difference value, it indicates that the infrared photographing module and the visible light photographing module have been registered in structures. They can receive a photographing instruction sent by the smart terminal or a photographing instruction sent by a user to the image photographing device. The photographing instruction carries photographing position information, and when a position of the image photographing device reaches the photographing position (or a UAV equipped with the image photographing device flies to the photographing position), the infrared photographing module is triggered to photograph to obtain a first band image, and the visible light photographing module is triggered to photograph to obtain a second band image.

In S302, a first band image and a second band image are obtained.

In S303, the first band image and the second band image are registered based on calibration parameters of the infrared photographing module and calibration parameters of the visible light photographing module.

In one embodiment, some feasible implementation manners included in S302 and S303 have been described in detail in the embodiments shown in FIG. 2 and will not be repeated here.

In S304, the registered second band image is converted into a grayscale image.

In one embodiment, to ensure accuracy of edge detection results, before performing an edge detection on the registered second band image, the 3-channel registered second band image needs to be converted into a 1-channel grayscale image.

In one embodiment, a method of converting the registered second band image into the grayscale image may be an average method, which means that 3-channel pixel values of a same pixel in the registered second band image are averaged, and a result is a pixel value of the same pixel in the grayscale image. According to this method, a pixel value in the grayscale image of each pixel in the registered second band image data can be calculated, and then a rendering is performed with the pixel value of each pixel in the grayscale image to obtain the grayscale image. In other embodiments, a method of converting the registered second band image into the grayscale image may also be a weighted method and a maximum value method, and the embodiments of the present disclosure are not enumerated one by one.

In S305, an edge detection is performed on the grayscale image to obtain an edge image.

In one embodiment, a method for performing the edge detection on the grayscale image to obtain the edge image may include: performing denoising on the grayscale image to obtain a denoised grayscale image; performing an edge enhancement processing on the denoised grayscale image to obtain a grayscale image to be processed; and performing the edge detection on the grayscale image to be processed to obtain the edge image.

To reduce influence of noise on edge detection results in an image environment, a first step in an edge detection on the grayscale image is to denoise the grayscale image. In one embodiment, a Gaussian smoothing can be used to remove noise in the grayscale image, and smooth the image. After the grayscale image is denoised, some edge features in the grayscale image may be blurred. Edges of the grayscale image can be enhanced by an edge enhancement processing operation. After obtaining the grayscale image after the edge enhancement processing, the grayscale image may be subjected to an edge detection processing, thereby obtaining the edge image.

For example, it is supposed that a Canny operator can be used in the embodiments of the present disclosure to perform an edge detection on an edge-enhanced grayscale image, including calculating gradient intensity and a direction of each pixel in an image, non-maximum suppression, double threshold detection, suppress isolated threshold points, etc.

In S306, a fusion processing is performed on the registered first band image and the edge image to obtain a target image.

In one embodiment, a Poisson fusion algorithm may be used to fuse the registered first band image and the edge image to obtain the target image. Alternatively, using the Poisson fusion algorithm to fuse the registered first band image and the edge image to obtain the target image may include: superimposing the registered first band image and the edge images to obtain an image to be fused; obtaining a color value of each pixel in the image to be fused; and rendering the image to be fused based on the color value of each pixel in the image to be fused, and determining the rendered image to be fused as the target image.

A main idea of the Poisson fusion algorithm is to reconstruct image pixels in a composite area by interpolation based on gradient information of a source image and boundary information of a target image. In the embodiments of the present disclosure, the source image may refer to any one of a registered first band image and an edge image, and the target image refers to another one of the registered first band image and the edge image. Reconstructing the image pixels of the composite area can be understood as recalculating the color value of each pixel in an image to be fused.

In one implementation, obtaining the color value of each pixel in the image to be fused includes: obtaining a gradient field of the image to be fused; calculating a divergence value of each pixel of the image to be fused based on the gradient field of the image to be fused; and determining the color value of each pixel in the image to be fused based on the divergence value of each pixel in the image to be fused and a color value calculation rule. Normally, various image processing such as an image enhancement, an image fusion, and an image edge detection and segmentation are done in a gradient domain of the image. Using the Poisson fusion algorithm for an image fusion is no exception.

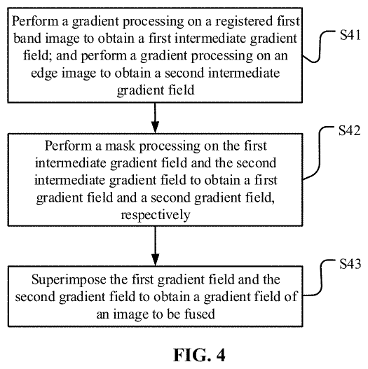

To fuse the registered first band image and the edge image in a gradient field, a gradient field of the image to be fused must be obtained first. In one embodiment, a method of obtaining the gradient field of the image to be fused may be based on a gradient field of the registered first band image and a gradient field of the edge image. Alternatively, obtaining the gradient field of the image to be fused includes S41, S42, and S43 shown in FIG. 4.

In S41, a gradient processing is performed on the registered first band image to obtain a first intermediate gradient field, and a gradient processing is performed on the edge image to obtain a second intermediate gradient field.

In S42, a mask processing is performed on the first intermediate gradient field to obtain a first gradient field, and a mask processing is performed on the second intermediate gradient field to obtain a second gradient field.

In S43, the first gradient field and the second gradient field are superimposed to obtain the gradient field of the image to be fused.

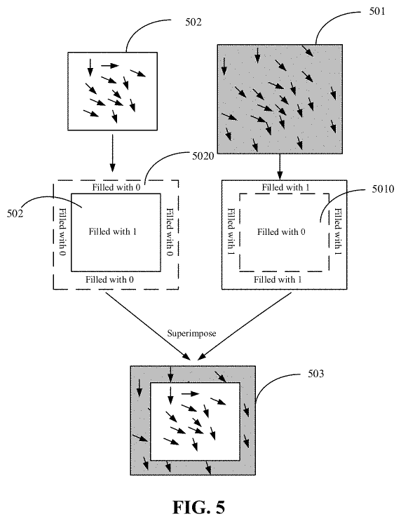

The image photographing device can obtain the first intermediate gradient field and the second intermediate gradient field by a differential method. In one embodiment, the above method for obtaining the gradient field of the image to be fused is mainly used when the registered first band image and the edge image have different sizes. The mask processing is to obtain the first gradient field and the second gradient field of a same size, so that the first gradient field and the second gradient field can be directly superimposed to obtain the gradient field of the image to be fused. For example, in FIG. 5, a schematic diagram of obtaining a gradient field of an image to be fused according to various exemplary embodiments of the present disclosure, it is assumed that 501 is a first intermediate gradient field obtained by performing a gradient processing on a registered first band image, and 502 is a second intermediate gradient field obtained by performing a gradient processing on an edge image. 501 and 502 are different in size. A mask processing is performed on 501 and 502 respectively. A mask processing is performed on 502 that a difference portion 5020 between 502 and 501 is completed and filled with 0, and 502 is filled with 1. A mask processing is performed on 501 that a part 5010 with a same size as 502 is subtracted from 501, and filled with 0, and a remaining part of 501 is filled with 1. In the embodiments of the present disclosure, it is assumed that a portion filled with 1 means that an original gradient field is kept unchanged, and a portion marked with 0 means that a gradient field needs to be changed. 501 after the mask processing and 502 after the mask processing are directly superimposed to obtain a gradient field of an image to be fused, such as 503. Since 501 after the mask processing is the same size as 502 after the mask processing, 503 can also be regarded to cover a gradient field of an area filled with 0 in 501 and 502 after the mask processing with a gradient field of an area filled with 1 in 501 and 502 after the mask processing.

In other embodiments, if a registered first band image and an edge image have a same size, a method for obtaining a gradient field of an image to be fused is to use a first intermediate gradient field or a second intermediate gradient field as the gradient field of the image to be fused.

In one embodiment, after obtaining the gradient field of the image to be fused, the image photographing device may perform calculating a divergence value of each pixel in the image to be fused based on the gradient field of the image to be fused, including: determining a gradient of each pixel based on the gradient field of the image to be fused, and deriving gradient of each pixel, to obtain the divergence value of each pixel.

In one embodiment, after determining the divergence value of each pixel, the image photographing device may perform determining a color value of each pixel in an image to be fused based on the divergence value of each pixel in the image to be fused and a color value calculation rule. The color value calculation rule refers to a rule for calculating a color value of a pixel. The color calculation rule may be a calculation formula or other rules. In the embodiments of the present disclosure, a color calculation rule is assumed to be a calculation formula Ax=b, where A represents a coefficient matrix of an image to be fused, x represents color values of pixels, and b represents divergence values of the pixels.

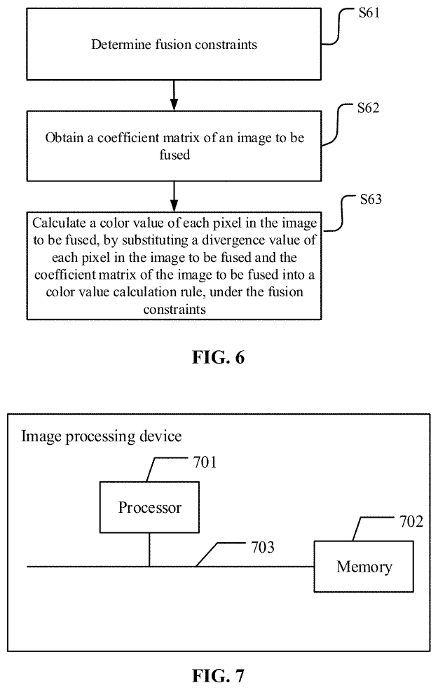

It can be known from the above formula that x can be calculated if A and b and other constraints are known. Alternatively, a method for calculating a color value of each pixel in the image to be fused based on a divergence value of each pixel in the image to be fused and a color calculation rule includes S61, S62, and S63 shown in FIG. 6.

In S61, fusion constraints are determined.

In S62, a coefficient matrix of the image to be fused is obtained.

In S63, a color value of each pixel in the image to be fused is calculated by substituting a divergence value of each pixel in the image to be fused and the coefficient matrix of the image to be fused into the color value calculation rule, under the fusion constraints.

The fusion constraints in the embodiments of the present disclosure refer to a color value of each pixel around the image to be fused. Alternatively, the color value of each pixel around the image to be fused may be determined according to a color value of each pixel around the registered first band image, or according to a color value of each pixel around the edge image. A method for determining a coefficient matrix of the image to be fused may include: listing various Poisson equations related to the image to be fused according to a divergence value of each pixel of the image to be fused; and constructing the coefficient matrix of the image to be fused according to the various Poisson equations.

After fusion constraints and a coefficient matrix of the image to be fused are determined, a color value of each pixel of the image to be fused is obtained by substituting a divergence value of each pixel in the image to be fused and the coefficient matrix into a color value calculation rule such as Ax=b, under the fusion constraints.

In the embodiments of the present disclosure, before obtaining an image, an infrared photographing module and a visible light photographing module are physically registered, and then a first band image and a second band image are obtained by using the infrared photographing module and the visible light photographing module after the infrared photographing module and the visible light photographing module are registered on physical structures. The first band image and the second band image are registered by an algorithm, an edge detection is performed on the registered second band image to obtain an edge image, and the registered first band image and the edge image are fused to obtain a target image. An image that reflects both infrared radiation information of a subject and edge feature of the subject can be obtained, which improves image quality.

Referring to FIG. 7, a schematic structural diagram of an image processing device according to various exemplary embodiments of the present disclosure, an image processing device is shown in FIG. 7. The image processing device may include a processor 701 and a memory 702. The processor 701 and the memory 702 are connected to each other through a bus 703. The memory 702 is used to store program instructions.

The memory 702 may include a volatile memory, such as a random-access memory (RAM). The memory 702 may also include a non-volatile memory, such as a flash memory, a solid-state drive (SSD), etc. The memory 702 may also include a combination of the aforementioned types of memory.

The processor 701 may be a central processing unit (CPU). The processor 701 may further include a hardware chip. The hardware chip may be an application-specific integrated circuit (ASIC), a programmable logic device (PLD), and so on. The PLD may be a field-programmable gate array (FPGA), a general-purpose array logic (GAL), and so on. The processor 701 may also be a combination of the above structures.

In the embodiments of the present disclosure, the memory 702 is used to store a computer program, and the computer program includes program instructions, and the processor 701 is configured to execute the program instructions stored in the memory 702 to implement corresponding methods in the above-described embodiments shown in FIG. 2.

In one embodiment, the processor 701 is configured to execute program instructions stored in the memory 702 to implement the corresponding methods in the embodiments shown in FIG. 2 above. The processor 701 is configured to invoke the program instructions to perform: obtaining a first band image and a second band image; registering the first band image and the second band image; performing an edge detection on the registered second band image to obtain an edge image; and performing a fusion processing of the registered first band image and the edge image to obtain a target image.

In one embodiment, for performing the edge detection on the registered second band image to obtain the edge image, the processor 701 is configured to perform following operations: converting the registered second band image into a grayscale image; and performing the edge detection on the grayscale image to obtain the edge image.

In one embodiment, for performing the edge detection on the grayscale image to obtain the edge image, the processor 701 is configured to perform following operations: performing denoising on the grayscale image to obtain a denoised grayscale image; performing an edge enhancement processing on the denoised grayscale image to obtain a grayscale image to be processed; and performing the edge detection on the grayscale image to be processed to obtain the edge image.

In one embodiment, for performing the fusion processing of the registered first band image and the edge image to obtain the target image, the processor 701 is configured to perform following operations: superimposing the registered first band image and the edge images to obtain an image to be fused; obtaining a color value of each pixel in the image to be fused; and rendering the image to be fused based on the color value of each pixel in the image to be fused, and determining the rendered image to be fused as the target image.

In one embodiment, for obtaining the color value of each pixel in the image to be fused, the processor 701 is configured to perform following operations: obtaining a gradient field of the image to be fused; calculating a divergence value of each pixel in the image to be fused, based on the gradient field of the image to be fused; and calculating a color value of each pixel in the image to be fused, based on the divergence value of each pixel in the image to be fused and a color value calculation rule.

In one embodiment, for obtaining the gradient field of the image to be fused, the processor 701 is configured to perform following operations: performing a gradient processing on the registered first band image to obtain a first intermediate gradient field; performing a gradient processing on the edge image to obtain a second intermediate gradient field; performing a mask processing on the first intermediate gradient field and the second intermediate gradient field respectively to obtain a first gradient field and a second gradient field; and superimposing the first gradient field and the second gradient field to obtain the gradient field of the image to be fused.

In one embodiment, for calculating the color value of each pixel in the image to be fused based on the divergence value of each pixel in the image to be fused and the color value calculation rule, the processor 701 is configured to perform following operations: determining fusion constraints; obtaining a coefficient matrix of the image to be fused; and calculating a color value of each pixel in the image to be fused by substituting the divergence value of each pixel in the image to be fused and the coefficient matrix of the image to be fused into the color value calculation rule, under the fusion constraints.

In one embodiment, the first band image is an infrared image, and the second band image is a visible light image. The infrared image is obtained by using an infrared photographing module provided on an image photographing device, and the visible light image is obtained by using a visible light photographing module provided on the image photographing device.

In one embodiment, for registering the first band image and the second band image, the processor 701 is configured to perform following operations: registering the first band image and the second band image, based on calibration parameters of the infrared photographing module and calibration parameters of the visible light photographing module.

In one embodiment, for registering the first band image and the second band image, based on the calibration parameters of the infrared photographing module and the calibration parameters of the visible light photographing module, the processor 701 is configured to perform following operations: obtaining the calibration parameters of the infrared photographing module and the calibration parameters of the visible light photographing module; performing adjustment of the first band image according to the calibration parameters of the infrared photographing module, and/or performing adjustment of the second band image according to the calibration parameters of the visible light photographing module. The adjustment includes one or more of rotation, scaling, translation, and cropping.

In one embodiment, by invoking the program instructions, the processor 701 may also be configured to perform: registering the infrared photographing module and the visible light photographing module, based on a position of the infrared photographing module and a position of the visible light photographing module.

In one embodiment, for registering the infrared photographing module and the visible light photographing module, based on the position of the infrared photographing module and the position of the visible light photographing module, the processor 701 is configured to perform following operations: calculating a position difference value between the infrared photographing module and the visible light photographing module according to a position of the infrared photographing module relative to the image photographing device and a position of the visible light photographing module relative to the image photographing device; and if the position difference value is greater than or equal to a preset position difference value, triggering adjustment of the position of the infrared photographing module or the position of the visible light photographing module, so that the position difference value is less than the preset position difference value.

In one embodiment, for registering the infrared photographing module and the visible light photographing module, based on the position of the infrared photographing module and the position of the visible light photographing module, the processor 701 may also be configured to perform following operations: determining whether the position of the infrared photographing module and the position of the visible light photographing module satisfy a horizontal distribution condition; and if the position of the infrared photographing module and the position of the visible light photographing module do not satisfy the horizontal distribution condition, triggering adjustment of the position of the infrared photographing module or the position of the visible light photographing module, so that the central horizontal distribution condition is satisfied between the infrared photographing module and the visible light photographing module.

In one embodiment, by invoking the program instructions, the processor 701 may also be configured to perform: aligning the registered first band image with the edge image, based on feature information of the registered first band image and feature information of the edge image.

In one embodiment, for aligning the registered first band image with the edge image, based on the feature information of the registered first band image and the feature information of the edge image, the processor 701 is configured to perform following operations: obtaining the feature information of the registered first band image and the feature information of the edge image; determining a first offset of the feature information of the registered first band image relative to the feature information of the edge image; and adjusting the registered first band image according to the first offset.

In one embodiment, for aligning the registered first band image with the edge image, based on the feature information of the registered first band image and the feature information of the edge image, the processor 701 is configured to perform also following operations: obtaining the feature information of the registered first band image and the feature information of the edge image; determining a second offset of the feature information of the edge image relative to the feature information of the registered first band image; and adjusting the edge image according to the second offset.

One embodiment of the present disclosure provides a UAV including: a fuselage; a power system provided on the fuselage for providing flying power; an image photographing device mounted on the fuselage; and a processor, configured to perform: obtaining a first band image and a second band image; registering the first band image and the second band image; performing an edge detection on the registered second band image to obtain an edge image; and fusing the registered first band image and the edge image to obtain a target image.

In the embodiments of the present disclosure, a computer-readable storage medium is also provided. The computer-readable storage medium stores a computer program, and the computer program is executed by a processor to implement the image processing method shown in FIG. 2 or FIG. 3 according to the embodiments of the present disclosure, and also implement the image processing device shown in FIG. 7 according to the embodiments of the present disclosure. Details are not described herein again.

A person of ordinary skill in the art may understand that all or part of processes in the methods of the above embodiments can be completed by instructing relevant hardware through a computer program, and the computer program can be stored in a computer-readable storage medium. During execution, the processes in the methods of the above embodiments may be included. The computer-readable storage medium may be a magnetic disk, an optical disk, a read-only memory (ROM) or a random access memory (RAM), etc.

The above are only alternative implementations of the present disclosure, but the scope of protection of the present disclosure is not limited to these. Any person skilled in the art can easily think of changes or replacements within the technical scope disclosed in the present disclosure, which should be covered by the protection scope of the present disclosure. Therefore, the protection scope of the present disclosure shall be subject to the protection scope of the claims.

What is claimed is:

1. An image processing method, comprising:
obtaining a first band image and a second band image;
registering the first band image and the second band image;
performing an edge detection on the registered second band image to obtain an edge image; and
performing a fusion processing on the registered first band image and the edge image to obtain a target image.

2. The method according to claim 1, wherein performing the edge detection on the registered second band image to obtain the edge image includes:
converting the registered second band image into a grayscale image; and
performing the edge detection on the grayscale image to obtain the edge image.

3. The method according to claim 2, wherein performing the edge detection on the grayscale image to obtain the edge image includes:
denoising the grayscale image to obtain a denoised grayscale image;
performing an edge enhancement processing on the denoised grayscale image to obtain a grayscale image to be processed; and
performing the edge detection on the grayscale image to be processed to obtain the edge image.

4. The method according to claim 1, wherein performing the fusion processing on the registered first band image and the edge image to obtain the target image includes:
superimposing the registered first band image and the edge image to obtain an image to be fused;
obtaining a color value of each pixel in the image to be fused; and
rendering the image to be fused, based on the color value of each pixel in the image to be fused, and determining the rendered image to be fused as the target image.

5. The method according to claim 4, wherein obtaining the color value of each pixel in the image to be fused includes:
obtaining a gradient field of the image to be fused;
calculating a divergence value of each pixel in the image to be fused, based on the gradient field of the image to be fused; and
calculating the color value of each pixel in the image to be fused, based on the divergence value of each pixel in the image to be fused and a color value calculation rule.

6. The method according to claim 5, wherein obtaining the gradient field of the image to be fused includes:
performing a gradient processing on the registered first band image to obtain a first intermediate gradient field;
performing a gradient processing on the edge image to obtain a second intermediate gradient field;
performing a mask processing on the first intermediate gradient field to obtain a first gradient field, and performing a mask processing on the second intermediate gradient field to obtain a second gradient field; and
superimposing the first gradient field and the second gradient field to obtain the gradient field of the image to be fused.

7. The method according to claim 6, wherein calculating the color value of each pixel in the image to be fused, based on the divergence value of each pixel in the image to be fused and the color value calculation rule, includes:
determining fusion constraints;
obtaining a coefficient matrix of the image to be fused; and
calculating the color value of each pixel in the image to be fused, by substituting the divergence value of each pixel in the image to be fused and the coefficient matrix of the image to be fused into the color value calculation rule, under the fusion constraints.

8. The method according to claim 1, wherein:
the first band image is an infrared image, and the second band image is a visible light image; and
the infrared image is obtained by using an infrared photographing module provided on an image photographing device, and the visible light image is obtained by using a visible light photographing module provided on the image photographing device.

9. The method according to claim 8, wherein registering the first band image and the second band image includes:
registering the first band image and the second band image, based on calibration parameters of the infrared photographing module and calibration parameters of the visible light photographing module.

10. The method according to claim 9, wherein registering the first band image and the second band image, based on the calibration parameters of the infrared photographing module and the calibration parameters of the visible light photographing module, includes:
obtaining the calibration parameters of the infrared photographing module and the calibration parameters of the visible light photographing module; and
performing adjustment of the first band image according to the calibration parameters of the infrared photographing module, and/or performing adjustment of the second band image according to the calibration parameters of the visible light photographing module; wherein:
the adjustment includes one or more of rotation, scaling, translation, and cropping.

11. The method according to claim 8, wherein before obtaining the first band image and the second band image, the method further includes:
registering the infrared photographing module with the visible light photographing module, based on a position of the infrared photographing module and a position of the visible light photographing module.

12. The method according to claim 11, wherein registering the infrared photographing module with the visible light photographing module, based on the position of the infrared photographing module and the position of the visible light photographing module, includes:
calculating a position difference value between the infrared photographing module and the visible light photographing module according to a position of the infrared photographing module relative to the image photographing device and a position of the visible light photographing module relative to the image photographing device; and
if the position difference value is greater than or equal to a preset position difference value, triggering the adjustment of the position of the infrared photographing module or the position of the visible light photographing module, so that the position difference value is less than the preset position difference value.

13. The method according to claim 11, wherein registering the infrared photographing module with the visible light photographing module, based on the position of the infrared photographing module and the position of the visible light photographing module, includes:
determining whether a horizontal distribution condition is satisfied between the position of the infrared photographing module and the position of the visible light photographing module; and
if the horizontal distribution condition is unsatisfied between the position of the infrared photographing module and the position of the visible light photographing module, triggering the adjustment of the position of the infrared photographing module or the position of the visible light photographing module, so that the horizontal distribution condition is satisfied between the position of the infrared photographing module and the position of the visible light photographing module.

14. The method according to claim 1, wherein after performing the edge detection on the registered second band image to obtain the edge image, the method further includes:
aligning the registered first band image with the edge image, based on feature information of the registered first band image and feature information of the edge image.

15. The method according to claim 14, wherein aligning the registered first band image with the edge image, based on the feature information of the registered first band image and the feature information of the edge image, includes:
obtaining the feature information of the registered first band image and the feature information of the edge image;
determining a first offset of the feature information of the registered first band image relative to the feature information of the edge image; and
adjusting the registered first band image according to the first offset.

16. The method according to claim 15, further including:
obtaining the feature information of the registered first band image and the feature information of the edge image;
determining a second offset of the feature information of the edge image relative to the feature information of the registered first band image; and
adjusting the edge image according to the second offset.

17. An image processing device, comprising:
a memory, containing a computer program, the computer program including program instructions; and
a processor, coupled with the memory and, when the program instructions being executed, configured to perform:
obtaining a first band image and a second band image;
registering the first band image and the second band image;
performing an edge detection on the registered second band image to obtain an edge image; and
performing a fusion processing on the registered first band image and the edge image to obtain a target image.

18. The device according to claim 17, wherein for performing the edge detection on the registered second band image to obtain the edge image, the processor is configured to preform:
converting the registered second band image into a grayscale image; and
performing edge detection on the grayscale image to obtain the edge image.

19. The device according to claim 17, wherein for performing the fusion processing on the registered first band image and the edge image to obtain the target image, the processor is configured to perform:
superimposing the registered first band image and the edge image to obtain an image to be fused;
obtaining a color value of each pixel in the image to be fused; and
rendering the image to be fused, based on the color value of each pixel in the image to be fused, and determining the rendered image to be fused as the target image.

20. An unmanned aerial vehicle (UAV), comprising:
a fuselage;
a power system, provided on the fuselage for providing flying power;
an image photographing device, mounted on the fuselage; and
a processor, configured to perform:
obtaining a first band image and a second band image;
registering the first band image and the second band image;
performing an edge detection on the registered second band image to obtain an edge image; and
performing a fusion processing on the registered first band image and the edge image to obtain a target image.
